(19) United States
(12) Patent Application Publication
(10) Pub. No.: US 2009/0023431 A1
(43) Pub. Date: Jan. 22, 2009

(54) Systems and Methods for Communicating with a Network Switch

(75) Inventors: Soon Peng Jason Sim, Singapore (SG); Chee Yung Tan, Singapore (SG); Kum Cheong Adam Chan, Singapore (SG); Koon Gee Ho, Singapore (SG); Chi Hock Goh, Singapore (SG); Chen Chin Jimmy Wong, Singapore (SG); Wee Yi Lee, Singapore (SG); Koh Yew Thoon, Singapore (SG); Lay Wei Ang, Singapore (SG)

Correspondence Address: Hewlett-Packard Company, Intellectual Property Administration, P.O. Box 272400, Ft. Collins, CO, 80527-2400, US

(73) Assignee: HEWLETT-PACKARD DEVELOPMENT COMPANY, L.P., Ft. Collins, CO (US)

(21) Appl. No.: 11/779,919

(22) Filed: Jul. 19, 2007

(51) Int. Cl. H04M 3/00

(52) U.S. Cl. 455/418

(57) ABSTRACT

Systems and methods for communicating with a network device are provided. In this regard, a representative system, among others, includes a network switch associated with a telecommunications device; and a wireless interface device that wirelessly communicates with the network switch, the wireless interface device being configured to obtain information associated with the network switch and display at least a portion of the information obtained on a display device. A representative method, among others, for communicating with a network switch includes establishing a wireless link between the network switch and a wireless interface device; obtaining information associated with the network switch by the wireless interface device via the wireless link; and displaying at least a portion of the information obtained on a display device of the wireless interface device.

### TECHNICAL FIELD

The present disclosure relates to a network switch, more particularly, the disclosure relates to systems and methods for communicating with a network switch.

### BACKGROUND

A network switch is a data link layer networking device that, for example, connects multiple network segments in a majority of Ethernet local area networks or LANS. Typically, when a new switch is added into such a network, a network administrator configures the network switch on a work bench before electrically connecting the switch to the network. The network switch is typically placed on a switch rack along with other network switches. If the switch has technical problems, the network administrator has to physically find the problematic network switch, connect the problematic network switch to a network administrator computing device via a wire, and fix the problematic switch using the network administrator computing device.

### SUMMARY

Systems and methods for communicating with a network device are provided. In this regard, a representative system, among others, includes a network switch associated with a telecommunications device; and a wireless interface device that wirelessly communicates with the network switch, the wireless interface device being configured to obtain information associated with the network switch and display at least a portion of the information obtained on a display device.

A representative method, among others, for communicating with a network switch includes establishing a wireless link between the network switch and a wireless interface device; obtaining information associated with the network switch by the wireless interface device via the wireless link; and displaying at least a portion of the information obtained on a display device of the wireless interface device.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a system overview that includes a wireless interface device and network switches.

FIG. 2 is a block diagram that illustrates an embodiment of the wireless interface device and the network switch, such as that shown in FIG. 1.

FIG. 3 is a security access flow diagram that illustrates an embodiment of the architecture, functionality, and/or operation of the system, such as that shown in FIG. 1.

FIG. 4 is a flow diagram that illustrates an embodiment of the architecture, functionality, and/or operation of the system, such as that shown in FIG. 1.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which a wireless interface device communicates with a network switch.

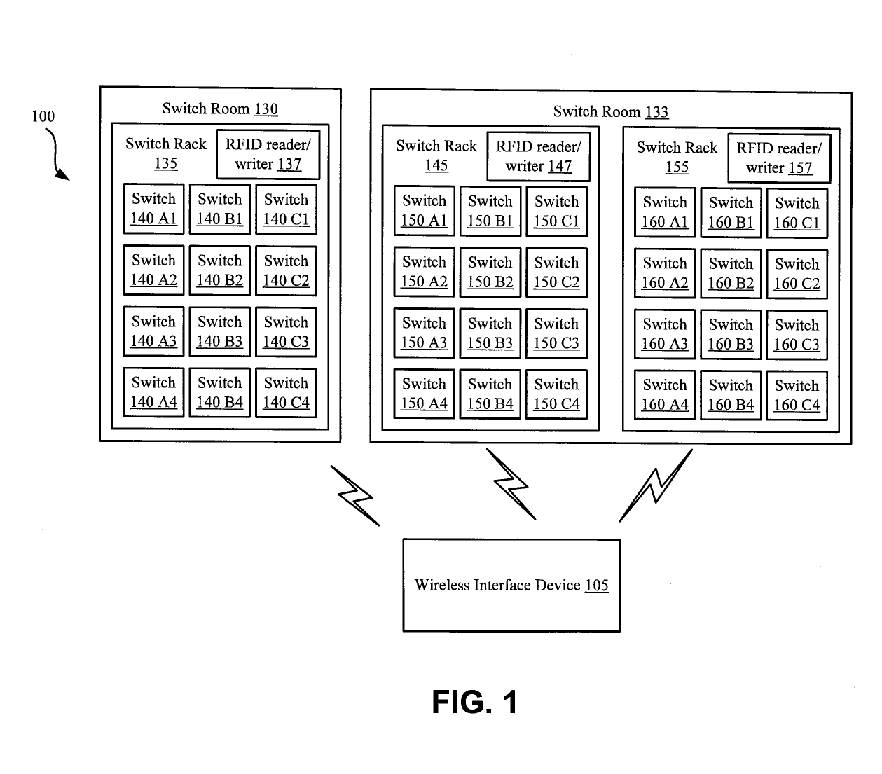

FIG. 1 is a system overview that includes a wireless interface device 105 and network switches 140, 150, 160. The wireless interface device 105 communicates wirelessly with the network switches 140, 150, 160, which are generally placed on switch racks 135, 145, 155, respectively. Each switch rack 135, 145, 155 includes columns A, B, C, and rows 1, 2, 3, and 4. It should be noted that the switch racks 135, 145, 155 can include more or less of the columns and rows than that shown in FIG. 1. Alternatively or additionally, the switch racks 135, 145, 155 can be merely shelves and are not designed to include columns.

Alternatively or additionally, the switch racks 135, 145, 155 include radio frequency identification (RFID) readers/writers 137, 147, 157, respectively, which are configured to program location information associated with the physical location of the network switches on the switch racks 135, 145, 155. The location information includes the information associated with a specific row and column that the network switch is placed on the switch rack, the location of the switch racks 135, 145, 155 in switch rooms 130, 133, the location of the switch rooms 130, 133 in a building (not shown), and the location of the building, among others.

Alternatively or additionally, the network switch 140, 150, 160 can include flash memory that contains the location information associated with the network switch 140, 150, 160. Other information can be stored in the flash memory such as the type of network switch and information associated with the type of service provided by the network switch 140, 150, 160. Any information stored in the flash memory can be transmitted to the wireless interface device 105.

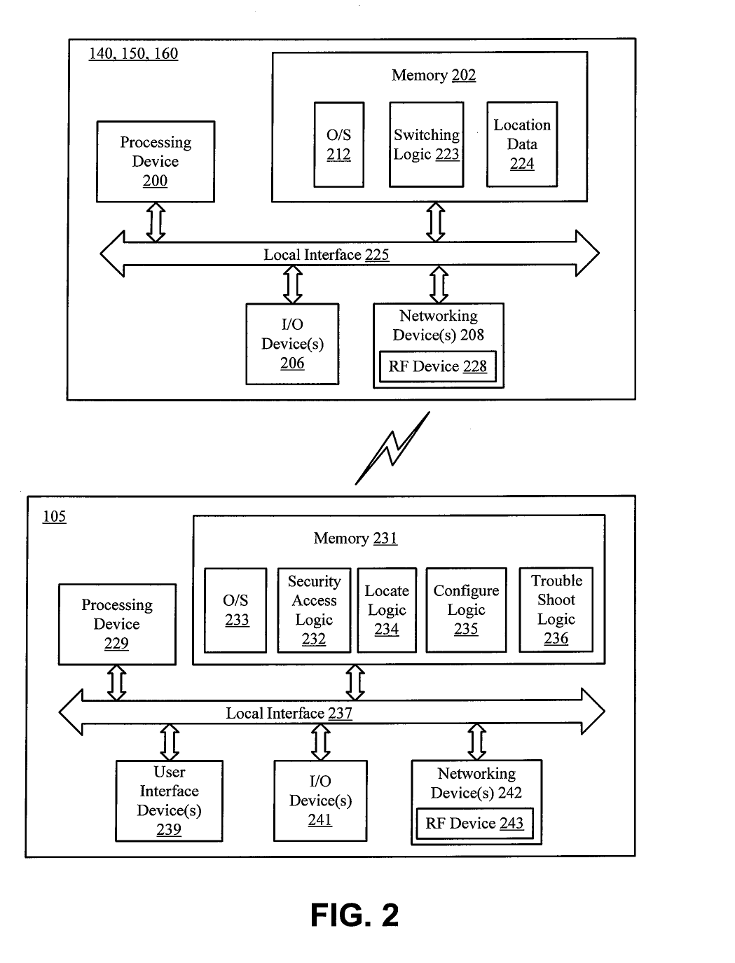

FIG. 2 is a block diagram that illustrates an embodiment of the wireless interface device 105 and the network switch 140, 150, 160, such as that shown in FIG. 1. As indicated in FIG. 2, the network switch 140, 150, 160 comprises a processing device 200, memory 202, one or more I/O devices 206, and networking devices 208, each of which is connected to a local interface 225. The processing device 200 can include any custom made or commercially available processor, a central processing unit (CPU) or an auxiliary processor among several processors associated with the network switch 140, 150, 160, a semiconductor based microprocessor (in the form of a microchip), or a macroprocessor.

The one or more I/O devices 206 comprise components used to facilitate connection of the network switch 140, 150, 160 to other devices and therefore, for instance, comprise one or more serial, parallel, small system interface (SCSI), universal serial bus (USB), or IEEE 1394 (e.g., Firewire™) connection elements. The networking devices 208 comprise the various components used to transmit and/or receive data over a telecommunication network (not shown), where provided. By way of example, the networking devices 208 include a device that can communicate both inputs and outputs, for instance, a modulator/demodulator (e.g., modem), a radio frequency (RF) device 228 or infrared (IR) transceiver, etc. The RF device 228 includes, but is not limited to, a transceiver, Bluetooth™ and 802.11 a/b/n devices, among others.

The memory 202 can include any one or a combination of volatile memory elements (e.g., random access memory (RAM, such as DRAM, SRAM, etc.)) and nonvolatile memory elements (e.g., ROM, hard drive, tape, CDROM, etc.). The memory 202 normally comprises various programs (in software and/or firmware) including an operating system (O/S) 212, network switching logic 223, and location data 224, among others. The O/S 212 controls the execution of programs, including the network switching logic 223, and provides scheduling, input-output control, file and data management, memory management, and communication control and related services. The network switching logic 223 facilitates connecting multiple network segments in the telecommunication network.

The architecture for the wireless interface device 105 is similar to the architecture of the network switch 140, 150, 160 described above and therefore includes a processing device 229, memory 231, one or more I/O devices 241, and one or more networking devices 242, each of which is connected to a local interface 237. The networking devices 242 include, but are not limited to, a RF device 243 that facilitates communicating wirelessly with the network switch 140, 150, 160. The RF device 243 includes, but is not limited to, a transceiver, Bluetooth™ and 802.11 a/b/n devices, among others.

The wireless interface device 105 further includes, however, one or more user interface devices 239, which comprise those components with which the user (e.g., network administrator) can interact with the wireless interface device 105. Where the network switch 140, 150, 160 comprises a laptop computer, portable computer or similar devices, these components can comprise those typically used in conjunction with a computer such as a display device, keyboard and mouse.

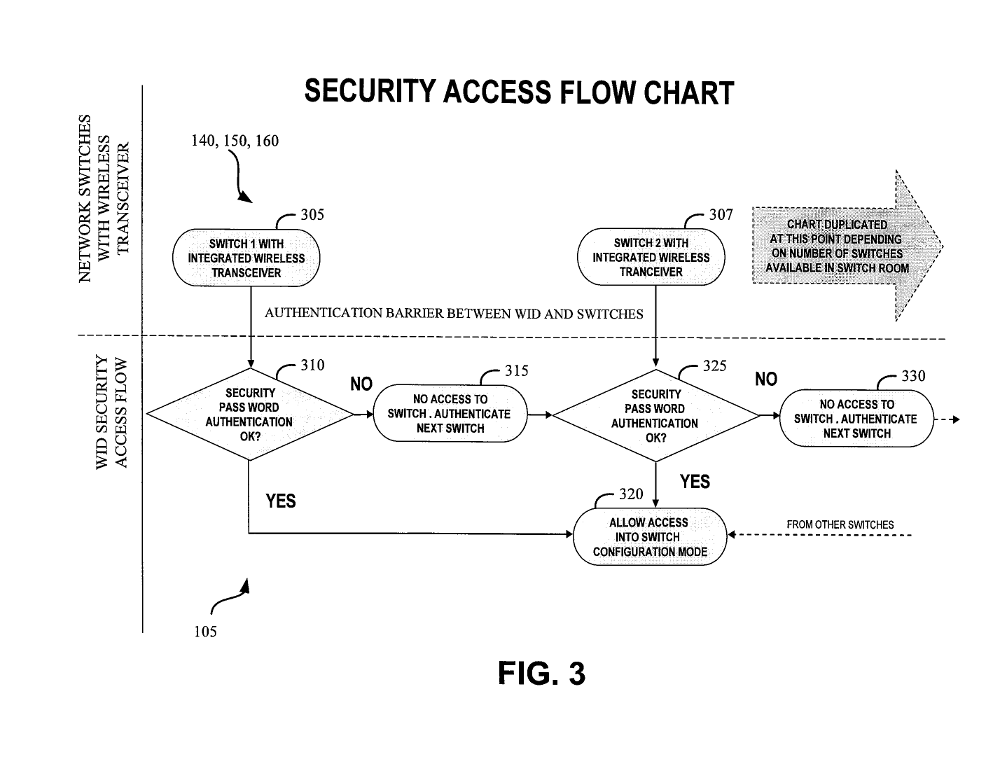

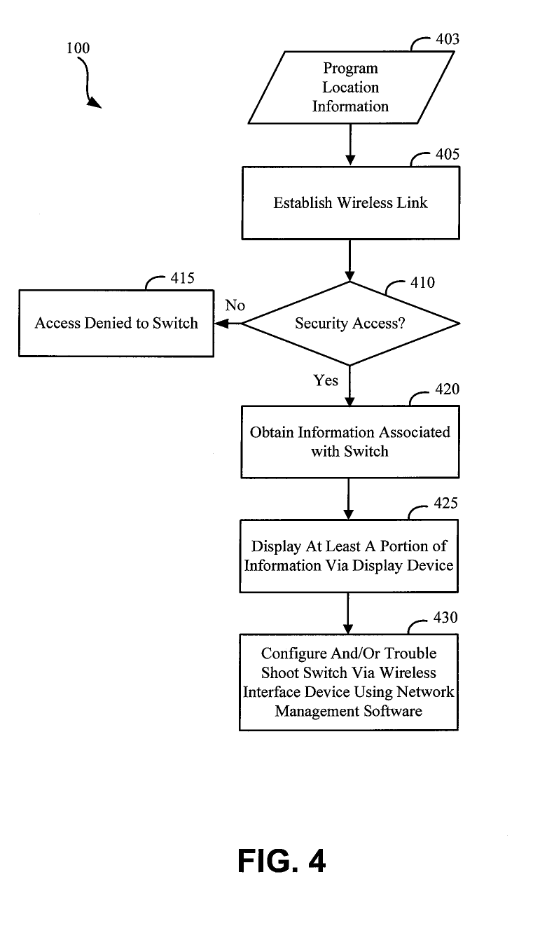

The memory 231 of the wireless interface device 105, however, includes security access logic 232, locate logic 234, configure logic 235 and trouble shoot logic 236 that facilitates accessing, physically locating, configuring, and trouble shooting the network switch 140, 150, 160, respectively. Operation of the security access logic 232, locate logic 234, configure logic 235 and trouble shoot logic 236 are described in relation to FIGS. 3-4.

FIG. 3 is a security access flow diagram that illustrates an embodiment of the architecture, functionality, and/or operation of the system 100, such as that shown in FIG. 1. Beginning with steps 305 and 307, the wireless interface device 105 detects network switches 140, 150, 160 that have wireless communication capabilities (e.g., RF device 228). The detected network switches 140, 150, 160 are generally in close proximity, approximately three to ten feet, from the wireless interface device 105.

The wireless interface device 105 begins a process of handshaking with the network switch 140, 150, 160. The “handshaking” is generally referred to as an automated process of negotiation that dynamically sets the parameters of a communications channel established between the network switch 140, 150, 160 and the wireless interface device 105 before normal communication over the channel begins. The handshaking process facilitates establishing a wireless link between the network switch 140, 150, 160 and the wireless interface device 105.

In step 310, a security access logic 232 (FIG. 2) determines whether the wireless interface device 105 has been authenticated to access and obtain information from the network switch 140, 150, 160. In one embodiment, the wireless interface device 105 can be authenticated using a password that is transmitted to the network switch 140, 150, 160. The authentication process can be executed using at least one of a wireless encryption protocol (WEP), wi-fi protected access (WPA) and a medium access control (MAC) access filtering. The WEP and WPA are generally referred to as a scheme to secure IEEE 802.11 wireless networks.

The MAC filtering is generally referred to as a security access control methodology whereby an address is assigned to each network switch 140, 150, 160 to determine access to the network switch. The MAC address is uniquely assigned to each network switch 140, 150, 160, and MAC filtering controls network access to specific network switches through the use of blacklists and whitelists.

If the authentication process is successful, step 320 accesses the network switch 140, 150, 160 to obtain information associated with the network switch and the wireless interface device 105 can, for example, locate, trouble shoot and configure the network switch 140, 150, 160. If the authentication process is unsuccessful at step 310, step 315 denies access to the network switch 140, 150, 160 and begins the authentication process with a second network switch 140, 150, 160 at step 325, which is similar to step 310. It should be noted that after the step 320 is completed, the wireless interface device 105 can begin the authentication process at step 325 with the second network switch 140, 150, 160. If the authentication process is unsuccessful at step 325, step 330 denies access to the second network switch 140, 150, 160 and begins the authentication process with a third network switch 140, 150, 160 (not shown).

Alternatively or additionally, the wireless interface device 105 can display a list of network switches 140, 150, 160 that are detected by the wireless interface device 105 during the handshaking process. A user can select at least one network switch from the list and then authenticate, access, trouble shoot, and configure the selected network switch.

FIG. 4 is a flow diagram that illustrates an embodiment of the architecture, functionality, and/or operation of the system 100. Beginning with 403, a RFID reader/writer 137, 147, 157 (FIG. 1) programs location information associated with the physical location of the network switch into the network switch 140, 150, 160. Step 405 establishes a wireless link between the wireless interface device 105 and the network switch 140, 150, 160.

Step 410 determines whether the wireless interface device 105 has security access to the network switch 140, 150, 160 by using an authentication process. In one embodiment, the authentication process includes, but is not limited to, at least one of a wireless encryption protocol (WEP), wi-fi protected access (WPA) and a medium access control (MAC) address filtering. At step 415, if the security access is denied, a security access logic 232 denies the wireless interface device 105 from accessing the network switch 140, 150, 160. At step 420, if the security access is successful, the wireless interface device 105 generally obtains information associated with the network switch 140, 150, 160.

In one embodiment, the wireless interface device 105 receives the location information associated with the network switch. Alternatively or additionally, the wireless interface device 105 can further receive fault-related information that describes the faulty condition of the network switch. The wireless interface device 105 displays the location information and/or fault-related information via a display device 239 of the wireless interface device 105. Alternatively or additionally, as shown in step 430, the wireless interface device 105 configures and troubleshoots the network switch 140, 150, 160 using the wireless interface device 105, which includes a network management software that facilitates the wireless interface device 105 to configure and troubleshoot the network switch 140, 150, 160.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, are suited to the particular use contemplated. All such modifications and variation are within the scope of this disclosure, as determined by the appended claims when interpreted in accordance with the breadth to which they are fairly and legally entitled.

What is claimed:

1. A wireless system comprising:
a network switch associated with a telecommunication network; and
a wireless interface device that wirelessly communicates with the network switch, the wireless interface device being configured to obtain information associated with the network switch and display at least a portion of the information obtained on a display device.

2. The wireless system as defined in claim 1, wherein the information associated with the network switch includes at least one of location information and fault-related information, the location information describing the physical location of the network switch, the physical location including at least one of building location information, switch room information, switch rack information, and row/column information, the fault-related information describing the faulty condition of the network switch.

3. The wireless system as defined in claim 2, wherein the network switch includes flash memory that contains the location information.

4. The wireless system as defined in claim 2, further comprising a radio frequency identification (RFID) reader/writer that programs the location information into the network switch.

5. The wireless system as defined in claim 1, wherein the information associated with the network switch further includes a switch type information describing the type of network switch and the service that the network switch provides.

6. The wireless system as defined in claim 1, wherein both of the wireless interface device and the network switch have radio frequency (RF) devices that facilitate wireless communication between the wireless interface device and the network switch.

7. The wireless system as defined in claim 6, wherein the wireless interface device establishes a wireless access to the network switches using at least one of a wireless encryption protocol (WEP), wi-fi protected access (WPA) and a medium access control (MAC) address filtering.

8. The wireless system as defined in claim 1, wherein the wireless interface device obtains the information associated with the network switch to trouble shoot the network switch.

9. The wireless system as defined in claim 1, wherein the wireless interface device is further configured to change the configurations of the network switch.

10. A method for communicating with a network switch, the method comprising:
establishing a wireless link between a network switch and a wireless interface device;
obtaining information associated with the network switch by the wireless interface device via the wireless link; and
displaying at least a portion of the information obtained on a display device of the wireless interface device.

11. The method as defined in claim 10, further comprising programming the network switch to include location information that describes the physical location of the network switch, the physical location including at least one of building location information, switch room information, switch rack information, and row/column information.

12. The method as defined in claim 11, wherein obtaining information associated with the network switch comprises using a radio frequency (RF) device.

13. The method as defined in claim 12, wherein establishing the wireless link comprises establishing a wireless access to the network switch using at least one of a wireless encryption protocol (WEP), wi-fi protected access (WPA) and a medium access control (MAC) address filtering.

14. The method as defined in claim 10, further comprising trouble shooting or configuring the network switch using the wireless interface device.

15. A wireless interface device comprising:
a radio frequency (RF) device that facilitates wireless communication with a network switch;
memory that includes logic to obtain information associated with the network switch via the RF device; and
a display device that displays at least a portion of the information obtained.

16. The wireless interface device as defined in claim 15, wherein the information associated with the network switch includes at least one of location information and fault-related information, the location information describing the physical location of the network switch, the physical location including at least one of building location information, switch room information, switch rack information, and row/column information, the fault-related information associated with the network switch describing the faulty condition of the network switch.

17. The wireless interface device as defined in claim 15, wherein the information associated with the network switch further includes information associated with the type of service provided by the network switch.

18. The wireless interface device as defined in claim 15, wherein the memory includes security access logic that establishes a wireless access to the network switches using at least one of a wireless encryption protocol (WEP), wi-fi protected access (WPA) and a medium access control (MAC) address filtering.

19. The wireless interface device as defined in claim 16, wherein the memory includes trouble shooting logic that is configured to obtain the information associated with the network switch to trouble shoot the network switch.

20. The wireless interface device as defined in claim 16, wherein the memory includes configure logic that is configured to change the configurations of the network switch.
